(19) United States
(12) Patent Application Publication
(10) Pub. No.: US 2026/0359267 A1
(43) Pub. Date: Nov. 12, 2026

(54) CONTENT MONITORING AND ALERTS FOR DOCUMENT MANAGEMENT

(71) Applicant: KYOCERA Document Solutions Inc., Osaka (JP)

(72) Inventor: Selim Zaman, San Mateo, CA (US)

(21) Appl. No.: 19/202,875

(22) Filed: May 8, 2025

(51) Int. Cl. G06F 16/174; G06F 16/11; G06F 16/334

(52) U.S. Cl. CPC G06F 16/1748; G06F 16/113; G06F 16/3344

(57) ABSTRACT

Systems and methods relate generally to document management. In a method for a data processing system one or more data cells may be defined to look at in a document class by an administrator programmed therein. The administrator may automatically compare a document with existing documents in a database belonging to the document class with respect to the one or more data cells. The database may be searched for matching content between the document and the documents in the database. It may be determined whether to send an alert to a document class manager for the document class responsive to a criteria being met. Responsive to the criteria being me, the document class manager may be alerted for to confirm a next operation for the document to enhance storage resource utilization of the data processing system. The next operation may select removing or archival storage of the duplicate content.

### FIELD

The following description relates to data processing. More particularly, the following description relates to content monitoring and alerts for document management.

### BACKGROUND

Generally, conventional document monitoring and reconciliating is limited to historical revision record keeping. This tends to consume significant amounts of storage with revision upon revision being stored.

Accordingly, it would be desirable and useful to provide a more flexible approach to document monitoring and reconciliating among versions. It would be additionally desirable and useful if such relatively more flexible approach further consumed less storage resources than conventional document monitoring and reconciliating.

### SUMMARY

In accordance with one or more below described examples, a method relating generally to document management is disclosed. In a data processing system having a memory, such a method includes computer-implemented operations. These operations can include: defining one or more data cells to look at in a document class by an administrator programmed in the data processing system; automatically comparing by the administrator a document with existing documents in a database belonging to the document class of the document with respect to the one or more data cells for the document class; searching across the database to look for matching content between the document and the documents in the database; determining whether to send an alert to a document class manager for the document class responsive to a criteria being met; responsive to the criteria being met for the document in the database as found by the administrator, alerting the document class manager for the document class to confirm a next operation for the document to enhance storage resource utilization of the data processing system; wherein the next operation is selected from a group of: removing duplicate content from the document found in the database and pointing to the duplicate content stored in the database; or sending either the document or the duplicate content to archival storage.

In accordance with one or more below described examples, a system relating generally to document management is disclosed. In such a system, there is equipment for document processing with each having a memory configured to store program code and a processor coupled to the memory. The system further includes a cloud-based application of a cloud computing system in networked communication with the equipment. In combination and response to executing the program code, the equipment and the cloud-based application combination is configured to facilitate performance of operations. These can include: uploading a document that is either a newly uploaded or an edited version to documents in a database; defining one or more data cells to look at with a monitoring criteria by an administrator programmed in the data processing system; automatically comparing by the administrator a document with existing documents in a database belonging to the document class of the document with respect to the one or more data cells for the document class; searching across the database to look for matching content between the document and the documents in the database; determining whether to send an alert to a document class manager for the document class responsive to a criteria being met; and responsive to the criteria being met for the document in the database as found by the administrator, alerting the document class manager for the document class to confirm a next operation for the document to enhance storage resource utilization of the data processing system. The next operation can be selected from a group of: removing duplicate content from the document found in the database and pointing to the duplicate content stored in the database; or sending either the document or the duplicate content to archival storage.

In accordance with one or more below described examples, a machine-readable storage medium relating generally to document management is disclosed. In such a machine-readable storage medium, executable instructions that, when executed by a processor, facilitate performance of operations. The operations can include: uploading a new or edited version document to documents in a database; defining data cells for a criteria for a document class to use by an administrator programmed in a data processing system; searching for content matches between the document and the documents in the database in the document class; identifying one or more document matches responsive to the searching for the content matches; identifying each change in the data cells of the monitoring criteria for each of the one or more document matches; searching for metadata matches between the document and the documents in the database; identifying one or more metadata matches; identifying content duplicates between the document and each corresponding one of the documents in the database associated with the one or more metadata matches; sending an alert to a document class manager responsive to the content duplicates and each said change in the data cells; approving the uploading by the document class manager of the document; and determining by the document class manager storage instructions associated with storing the document.

Other features will be recognized from consideration of the Detailed Description and Claims, which follow.

### BRIEF DESCRIPTION OF THE DRAWINGS

Accompanying drawings show exemplary apparatus(es) and/or method(s). However, the accompanying drawings should not be taken to limit the scope of the claims, but are for explanation and understanding only.

FIG. 1 is a block-flow diagram depicting an example of a data processing architecture having a document processing system configured for computer-implemented content monitoring and alerting for document management.

FIG. 2 is a block-flow diagram depicting an example of a document processing flow configured for computer-implemented content monitoring and alerting for document management.

FIG. 3 is a flow-block diagram depicting an example of a layered architecture for an example of a document processing flow of FIG. 2.

FIG. 4 is a pictorial diagram depicting an example of a network.

FIG. 5 is a block diagram depicting an example of a portable communication device.

FIG. 6 is a block diagram depicting an example of a multi-function printer (MFP).

FIG. 7 is a block diagram depicting an example of a computer system.

### DETAILED DESCRIPTION

In the following description, numerous specific details are set forth to provide a more thorough description of the specific examples described herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same number labels are used in different diagrams to refer to the same items; however, in alternative examples the items may be different.

Exemplary apparatus(es) and/or method(s) are described herein. It should be understood that the word “exemplary” is used herein to mean “serving as an example, instance, or illustration.” Any example or feature described herein as “exemplary” is not necessarily to be construed as preferred or advantageous over other examples or features.

Before describing the examples illustratively depicted in the several figures, a general introduction is provided to further understanding.

In a conventional document management system, document monitoring and reconciliating generally is limited to historical revision record keeping. This tends to consume significant amounts of storage with revision upon revision being stored.

However, a new document upload or editing an existing document may result in substantially matching contents. As described below in additional detail, an existing document matching such an upload or edited version may provide an opportunity for storage enhancement, namely utilization reduction, such as either by removing each duplicate document or split-aggregate file storage to reduce storage utilization.

As described below in additional detail, automatic content monitoring and alerts based on content matching with existing documents belonging to a same document class is described. Furthermore, pre-defined targeted fields within the document may be looked at to determine whether to alert a document manager for approval to upload. More particularly, documents may be sorted into corresponding classes. For example, a contract for financing may be sorted into a legal-financial contract class.

For purposes of clarity and not limitation, the following general definitions are provided. As described below in additional detail, a “document owner” may be an author or drafter of a document for uploading or editing, where such “document owner” is responsible for content of such a document; and a “document class” may be a category of documents having same or similar knowledge content. A “document class” may be aligned with organizational business processes of an entity. Moreover, forming one or more document classes may be automated using an ontological-based or other knowledgebase-based classification engine. A “document class manager” may be an owner and manager or just a manager of a document class in which various categorically same or similar documents reside. While a role of a “document class manger” may alternatively be called a “document class owner,” as described below a document class manager is just a manager of a document class, as a document class manager may be an agentic artificial intelligence, and a document class owner may be a human supervisor of such document class manager for supervised artificial intelligence.

Additional flexibility as described below in additional detail may be provided in configuring alert triggers for each document class. Along those lines, a document management system may relieve a document owner from having to monitor new documents and versions, as they will receive alerts set up by them through a configuration set in dashboard. Moreover, a document class manager may be programmed, such as an agent of an agentic artificial intelligence system, so human intervention may be reduced to supervision of such agent. A document class owner may be a default recipient of alerts, including without limitation passthrough alerts through a document class manager for supervised artificial intelligence (“ai”). In addition to a document class manager or a document class owner, other stakeholders, such as a document owner, may be added to receive alerts.

Beyond conventional document monitoring and reconciliation processing, a flexible, user-defined mechanism to monitor documents for duplication and target field changes is described below in additional detail. With the above general understanding borne in mind, various configurations for systems, and methods therefor, for content monitoring and alerts for document management are generally described.

Reference will now be made in detail to examples which are illustrated in the accompanying drawings. In the following detailed description, numerous specific details are set forth in order to provide a thorough understanding of the following described implementation examples. It should be apparent, however, to one skilled in the art, that the implementation examples described below may be practiced without all the specific details given below. Moreover, the example implementations are not intended to be exhaustive or to limit scope of this disclosure to the precise forms disclosed, and modifications and variations are possible in light of the following teachings or may be acquired from practicing one or more of the teachings hereof. The implementation examples were chosen and described in order to best explain principles and practical applications of the teachings hereof to enable others skilled in the art to utilize one or more of such teachings in various implementation examples and with various modifications as are suited to the particular use contemplated. In other instances, well-known methods, procedures, components, circuits, and/or networks have not been described in detail so as not to unnecessarily obscure the described implementation examples.

For purposes of explanation, specific nomenclature is set forth to provide a thorough understanding of the various concepts disclosed herein. However, the terminology used herein is for the purpose of describing particular examples only and is not intended to be limiting. As used herein, the singular forms “a”, “an” and “the” are intended to include the plural forms as well, unless the context clearly indicates otherwise. As used herein, the term “if” may be construed to mean “when” or “upon” or “in response to determining” or “in response to detecting,” depending on the context.

Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. It will also be understood that the term “and/or” as used herein refers to and encompasses any and all possible combinations of one or more of the associated listed items. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof. It will also be understood that, although the terms first, second, etc., may be used herein to describe various elements, these elements should not be limited by these terms, as these terms are only used to distinguish one element from another.

Some portions of the detailed descriptions that follow are presented in terms of algorithms and symbolic representations of operations on data bits, including within a register or a memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those involving physical manipulations of physical quantities. Usually, though not necessarily, these quantities take the form of optical, electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

Concepts described herein may be embodied as apparatus, method, system, or computer program product. Accordingly, one or more of such implementation examples may take the form of an entirely hardware implementation example, an entirely software implementation example (including firmware, resident software, and micro-code, among others) or an implementation example combining software and hardware, and for clarity any and all of these implementation examples may generally be referred to herein as a “circuit,” “module,” “system,” or other suitable terms. Furthermore, such implementation examples may be of the form of a computer program product on a computer-usable storage medium having computer-usable program code in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (“RAM”), a read-only memory (“ROM”), an erasable programmable read-only memory (“EPROM” or Flash memory), an optical fiber, a portable compact disc read-only memory (“CD-ROM”), an optical storage device, a transmission media such as those supporting the Internet or an intranet, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (“RF”) or other means. For purposes of clarity by way of example and not limitation, the latter types of media are generally referred to as transitory signal bearing media, and the former types of media are generally referred to as non-transitory signal bearing media.

Computer program code for carrying out operations in accordance with concepts described herein may be written in an object-oriented programming language such as Java, Smalltalk, C++ or the like. However, the computer program code for carrying out such operations may be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (“LAN”) or a wide area network (“WAN”), or the connection may be made to an external computer (for example, through the Internet using an Internet Service Provider).

Systems and methods described herein may relate to an apparatus for performing the operations associated therewith. This apparatus may be specially constructed for the purposes identified, or it may include a general-purpose computer selectively activated or reconfigured by a computer program stored in the computer.

Notwithstanding, the algorithms and displays presented herein are not inherently related to any particular computer or other apparatus. Various general-purpose systems may be used with programs in accordance with the teachings herein, or it may prove convenient to construct a more specialized apparatus to perform the operations. In addition, even if the following description is with reference to a programming language, it should be appreciated that any of a variety of programming languages may be used to implement the teachings as described herein.

One or more examples are described below with reference to flowchart illustrations and/or block diagrams of methods, apparatus (including systems) and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the Figures illustrate the architecture, functionality, and operation of possible implementations of apparatuses (including systems), methods and computer program products according to various implementation examples. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

It should be understood that although the flow charts provided herein show a specific order of operations, it is understood that the order of these operations may differ from what is depicted. Also, two or more operations may be performed concurrently or with partial concurrence. Such variation will depend on the software and hardware systems chosen and on designer choice. It is understood that all such variations are within the scope of the disclosure. Likewise, software and web implementations may be accomplished with standard programming techniques with rule-based logic and other logic to accomplish the various database searching operations, correlation operations, comparison operations and decision operations. It should also be understood that the word “component” as used herein is intended to encompass implementations using one or more lines of software code, and/or hardware implementations, and/or equipment for receiving manual inputs.

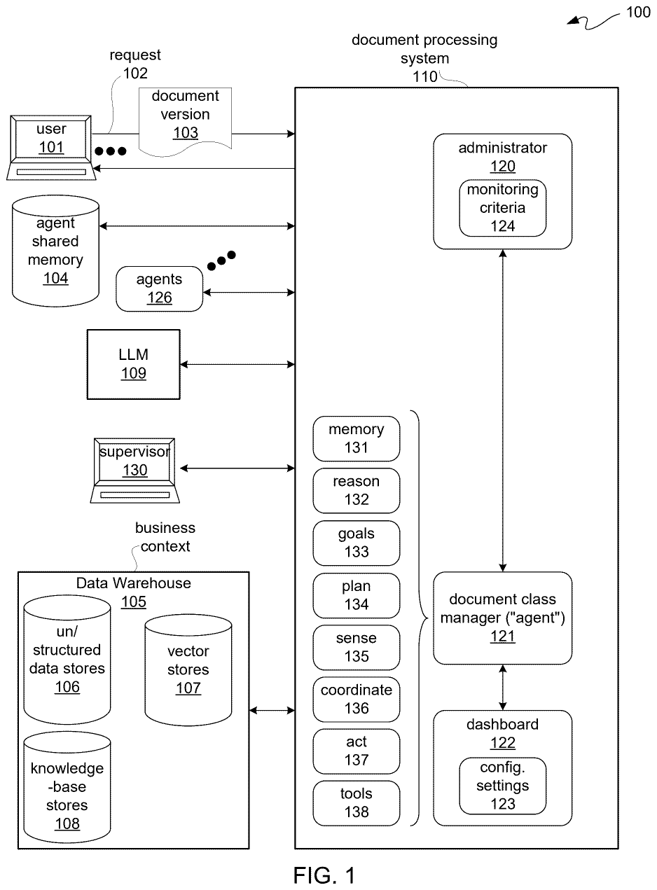

FIG. 1 is a block-flow diagram depicting an example of a data processing architecture 100 having a document processing system 110 configured for computer-implemented content monitoring and alerting for document management. Document processing system 110 may include an automated software system integrated into a cloud-information manager cloud platform. Such a platform may be used with a printing system, such as for example a multifunction printing device or MFP. Moreover, in this example data processing system 100 may be a cloud-based accessible system.

In this example, document processing system 110 may be in communication with one or more user electronic devices (“users”) 101 for receiving one or more requests 102 and may provide responses to such users with respect to such requests.

Document processing system 110 may include an administrator 120 and a document class manager (“agent”) 121 in communication with such administrator 120. In this example, administrator 120 and agent 121 are programmed in document processing system 110. However, in other examples, administrator 120 or agent 121 may be a combination of hardware and software/firmware.

Administrator 120 may be instantiated with a monitoring criteria 124 by agent 121. Such a monitoring criteria (“criteria”) 124 may be provided via a dashboard 122 accessible by agent 121. Dashboard 122 by be a tool of tools accessible by agent 121. Along those lines, agent 121 may have access to multiple modules, such as for example memory 131, reason 132, goals 133, plan 134, sense 135, coordinate 136, act 137, and tools 138. For example, sense or sense module 135 may include a multi-modal function such as via a camera, text, audio, and various sensors for perception, as is known. As each of these modules for an agentic ai is known, each of such modules is not described in unnecessary detail herein for purposes of clarity and not limitation.

Dashboard 122 may be configured to receive and set configuration settings 123. Along those lines, dashboard 122 may be used to configure trigger thresholds and to target specific fields for monitoring thereof. Configuration settings 123 may be for instantiating a criteria 124 for administrator 120. Additionally, a configuration template, accessible through dashboard 122, may allow agent 121 to define targeted data cells or fields to be monitored. Targeted fields may be defined through a dashboard 122 configuration per document class.

As document processing system 110 may be configured for handling multiple document classes, there may be multiple agents in such an agentic ai system even though a single agent 121 is illustratively depicted in this example for purposes of clarity and not limitation. Along those lines, an agent shared memory 104 may be coupled to document processing system 110 for sharing information with other agents, generally agents 126.

Agent 121, as well as other agents 126, may be in communication with a large language model (“LLM”) 109 as is known. LLM 109 may be used by agent 121 for or in support of such agent's perception, cognition, and/or action.

For purposes of clarity by way of example and not limitation, document processing system 110 is described in a business context. Along those lines, document classes may include a finance class, a marketing class, a sales class, a legal class, an operations class, and an executive decision class, among other classes. However, other non-business related classes may be used in other examples.

In this example, document processing system 110 is in communication with an enterprise data warehouse (“warehouse”) 105 generally for providing a digital business context. Such a warehouse 105 may include unstructured or structured data stores 106, vector stores 107, and optionally knowledgebase stores 108.

Knowledgebase stores 108 may be internal or external, as is known. Along those lines, a knowledge base may be used with ontological reasoning to determine a class for a document, if such class is not pre-identified in a user submission, such as for example a document version 103 via a request 102. Along those lines, document processing system 110 may be configured to automatically classify each document whether by ontological reasoning, user self-identification, or otherwise.

In this example, a human supervisor electronic device (“supervisor”) 130 may be in communication with document processing system 110. Supervisor 130 may be used for human supervision of agentic ai, as described below in additional detail.

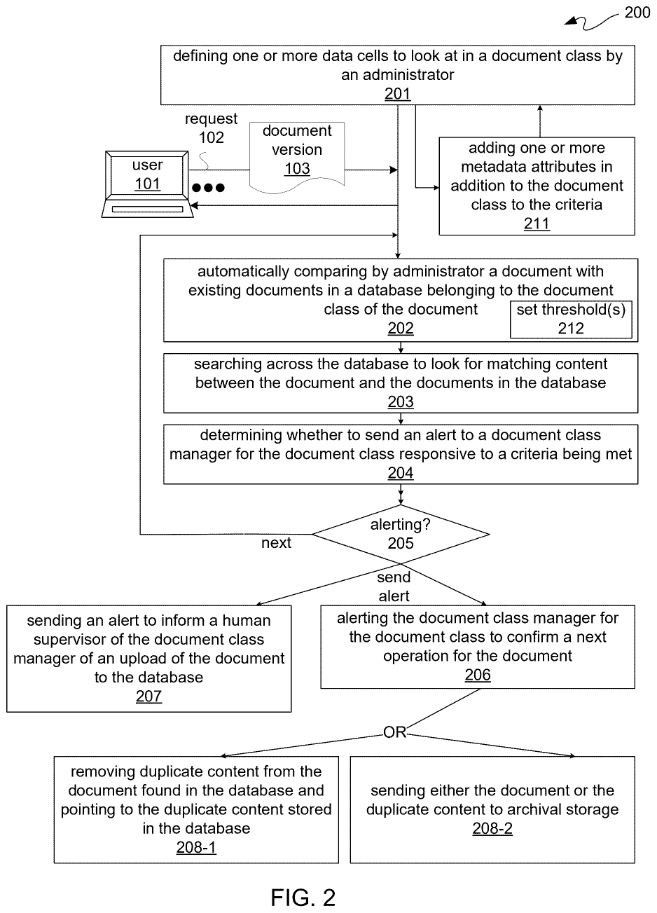

FIG. 2 is a block-flow diagram depicting an example of a document processing flow 200 configured for computer-implemented content monitoring and alerting for document management. With simultaneous reference to FIGS. 1 and 2, document processing flow 200 is further described.

At operation 201, one or more data cells are defined to look at in a document class by administrator 120 programmed in document processing system 110 of a data processing system 100. Such one or more data cells may be one or more fields predefined through configuration settings accessible via a dashboard 122 associated with a document class manager, such as agent 121.

Optionally, at operation 211, one or more metadata attributes may be added in addition to a document class to a criteria. Again, this criteria may be set using configuration settings 123 of dashboard 122 by agent 121. Optionally a supervisor 130 may use configuration settings 123 accessed via dashboard 122. Examples of metadata attributes may include department, document length, creation date, author, or other document metadata.

Configuration settings 123 may be used to set a criteria 124 via data cells for administrator 120. At operation 202, administrator 120 automatically compares a received document or document version 103 (hereinafter “document version 103”) with existing documents in a database 106 belonging to a document class of such document or document version 103 with respect to such one or more data cells for such document class. Such document or document version (“document”) may be either a newly uploaded document to database 106 or an edited version of a document of documents in database 106. This comparison may be responsive to one or more matching thresholds set at operation 212 for operation 202.

At operation 203, administrator 120 may search across documents in database 106 to look for matching content between document version 103 and such documents in such database. Content searching may be across all documents belonging to the same document class as an in-process document version 103 and also, optionally, any specified metadata attributes, to check for matching contents in database 106 with such document version 103. Searching at operation 203 may be an automatic search through all documents to look for changes of content or other fields based on a monitoring criteria.

By allowing the flexibility of configuring a monitoring criteria for each document class, document processing system 110 allows a supervisor 130 to customize document alerts sent at 205. It further allows agent 121 to learn from supervisor input for subsequent customizing of document alerts without user intervention. Optionally, to enhance a search, a pre-search may be used to develop a list of documents which contain defined content and date fields, and such list may be updated each time a document is uploaded or edited, or when a monitoring criteria changes.

Operations may be configurable to be performed synchronously as each document upload/edit event occurs. For example, operations may be configured to be performed periodically, e.g., once a day, every other day, or anytime on demand anytime by agent 121 to obtain a landscape view of existing documents to discover duplicates and potential contractual issues (e.g., contract expired, invoice overdue, etc.). Additionally, monitoring may be configured to be event-driven.

On-demand searching may be used for all documents in a same data class, as well as any selected metadata attributes, if a monitoring criteria 124 is modified in a configuration table such as for storing configuration settings 123, which may result in some existing documents having to have on demand review. Such on-demand searching through all documents in a database 106 belonging to the same document class, as well as any specified metadata attributes, may be used to check if a pre-configured targeted field has changed.

At operation 204, administrator 120 may determine whether to send an alert to an agent 121 for the document class of document version 103 responsive to a criteria being met. Whether or not an alert is sent at operation 205 responsive to a determination at 204, at operation 205 a next document version 103 to process may be fetched for a subsequent operation 202 for a document class.

Responsive to criterion, or more particularly a threshold for such criteria, being met for a document in database 106 as found by administrator 120, agent 121 for a corresponding document class may be alerted to confirm a next operation for in-process document version 103. This next operation may in effect enhance storage resource utilization of data processing system 100, as described below in additional detail, as such operation may effectively determine not to store a duplicate document for example. Optionally, at operation 207 in parallel with operation 206 an alert may be sent to inform a human or ai supervisor 130 of agent 121 for a document class of such agent 121 of an upload of document version 103 to database 106.

For purposes of clarity by way of example and not limitation, a criteria threshold based on settings at operation 212 may be having document contents match at least 90% between an in-process document version 103 and a document in database 106, and an administrator 120 may make a determination at operation 204 using one or more of such criteria threshold settings 212 as a criteria threshold. This criteria threshold may be a configurable threshold for an existing document belonging to the same document class and optionally some matching metadata attributes. This may be considered a “duplicate” for purposes of document management.

By not requiring a 100% match, documents may be considered duplicates without 100% certainty for purposes of reducing document storage resourcing. While an example of a 90% threshold is used, a lower matching threshold may be used to further reduce use of storage resources.

Furthermore, by automatic monitoring and alerting when a document is uploaded or edited and pre-specified or targeted data cells in a new or edited version match to at least beyond a threshold of a matching criteria other documents already stored and belonging to the same document class as that uploaded or edit document, human user intervention may be avoided. Though data cells are used as an example, such data cells may be for example data fields in a database. Optionally, some matching metadata attributes for a document may be automatically processed for such document class without having to have human intervention.

At operation 206, responsive to sending an alert at operation 205, alerting agent 121 may be alerted for a document class to confirm a next operation for an in-process document. Agent 121 may select either operation from operations 208-1 or 208-2 in this example. However, either or operations 208-1 and 208-2 may be selected in another example. Alerts may be either warning or confirmation alerts, which are sent to agent 121, optionally as well as other stakeholders, as may be specified in configuration settings 123 or obtained via ai learnt behavior.

Agent 121 or supervisor 130 may be sent an alert if an uploaded or edited document version 103 has contents in pre-defined targeted fields which contradict those in any documents in the same document class in documents in database 106.

However, generally a 90% matching criteria may be used. For purposes of clarity by way of example, a supervisor 130 may be sent an alert through dashboard 122 asking to confirm one of the following configurable actions: for a 90% matched document one is removed and one is stored (i.e., either the old or the new document may be stored but not both); for a 90% matched document, keep both for one month and then either document version 103 or its duplicate is removed (i.e., either the old or the new document is removed) from database 106; for a 90% matched document, moved either document version 103 or its duplicate to cold storage using a split-aggregate file storage (described below in additional detail); or do nothing. From instances of supervisor 130 actions, agent 121 may learn so supervisor 130 may avoid having to make decisions on 90% matched documents. Again, generally supervisor 130 may be sent an alert by a document class manager to inform a human supervisor of an approved document class manager upload of a document version 103 to database 106.

For selection of operation 208-1, duplicate content from a criteria matching document found in database 106 may be removed from such in process document, and a pointer or other vector may point to such duplicate content at a location stored in database 106. Along those lines, a vector store 107 may be used for storing such pointers or vectors in association with such in process document. Additionally, a store of document templates in database 106 may be used for pointing to a document thereof with a pointer, and then just storing in-process document version 103 specific content. This may be a form of a split-aggregation file storage. Along those lines, to reduce data storage requirements, page-wise split-aggregation may be used to store 100% matched pages in a common file, such as a template file, and then remaining pages with unmatched content-specific to document version 103 stored separately with split markers in reference to such common file with aggregation using of such matched pages and such content specific information using such split markers during retrieval. Split aggregation of a document by having pointing to a template for such document with duplicate content may be a form of document removal aside from nonduplicative document specific content.

For selection of operation 208-2, either an in-process document or the duplicate content thereof may be sent to archival storage, sometimes referred to as “cold storage” or “cold-level storage.” In another example, a variable matching criteria may be used for storage of documents. For example, a matching criteria may have multiple thresholds, such as for example a 70% threshold, an 80% threshold, and a 90% threshold. For those in-process documents at or above a 90% match threshold, such duplicate content may be considered “cold data” for storing in cold storage, such as slow or high latency hard disk storage; for those in-process documents at or above an 80% match threshold but below a 90% threshold, such duplicate content may be considered “warm data” for storing in “warm-level storage” or “warm storage,” such as faster or low latency hard disk storage but slow as compared with solid state disk (SSD) storage; and for those in-process documents at or above a 70% match threshold but below an 80% threshold, such duplicate content may be considered “hot data” for storing in “hot-level storage” or “hot storage,” such as faster or low latency SSD storage. Along those lines, generally cold storage costs less than warm storage, and warm storage costs less than hot storage. This is just one of many possible data storage ranking schemes.

Additionally, alerts may be correspondingly triaged. For example, an exact or 100% match may not need any alert to a supervisor 130; however, a more than 70% but less than 80% match may involve alerting a supervisor 130. Alerts may be displayed to supervisor 130 or other stakeholders through a dashboard 122, via emails, via text messages, via push notifications, or other message sending mediums.

To recapitulate, automatic content matching between new or edited documents and existing documents has been described. Automated alerting of a document class owner or their supervisor for appropriate storage action has been described. Automatic monitoring and alerting based on document content or data field changes based on pre-defined monitoring criteria has been described. Automated alerting of a document class manager for approval to upload a document has been described. Additionally, flexible system design that is configurable through a dashboard by document class manager has been described.

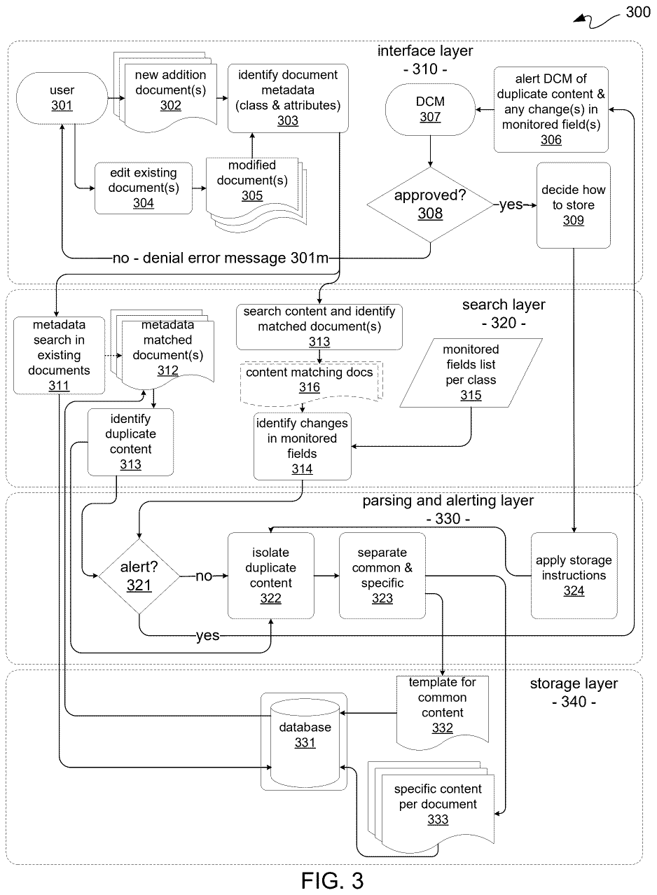

FIG. 3 is a flow-block diagram depicting an example of a layered architecture 300 for an example of a document processing flow 200 of FIG. 2. With simultaneous reference to FIGS. 1 through 3, layered architecture 300 is further described.

Layered architecture 300 in this example includes an interface layer 310, a search layer 320, a parsing and alerting layer 330, and a storage layer 340. Interface layer 310, which may be thought of as a user interface layer, for uploading documents, editing documents and controlling uploading of documents. Seach layer 320, which may be thought of as a content search layer, may be used to perform operations on uploaded or edited documents from interface layer 310 to identify matched content in stored documents. Again, a match or a duplicate as previously described need not require a 100% certainty, rather a less than 100% match or duplicate may be considered matching or duplicate content.

Parsing and alerting layer 330 may be used to generate alerts after comparison with existing documents. In this example, parsing and alerting layer 330 further includes operations to perform page-wise split-aggregation storage; however, as described elsewhere herein other forms of storage operation may be used. Lastly, storage layer 340 may be for storage of documents. Each of layers 310 through 340 are further described below in addition detail. Along those lines, operations of layers 310 through 340 may be at least in part implemented in a machine-readable storage medium having executable instructions that, when executed by a processor, facilitate performance of such operations.

Interface layer 310 generally includes reference numbers 301 through 309. At operations 301 a user may interface, such as with a computer, tablet, smart phone or other electronic device for document uploading or editing as previously described with reference to users 101, with interface layer 310. In this example, uploading and editing paths are broken out as two separate paths for purposes of clarity and not limitation, as a single path may be used for both. Generally, one or more new addition documents 302 may be newly uploaded to a database for a database operation 331 by a user. Also, one or more already database stored documents in database, such as database 106 for example, may be accessed for a database operation 331 and then may be edited at operation 304 to provide one or more edited existing documents 305.

Whether newly added or edited versions of documents, namely documents 302 or 305, such documents may be processed at operation 303 to identify document metadata, such as document class and optionally as well as one or more document attributes, as previously described. After uploading a document that is either a newly uploaded or an edited version to documents in a database, data cells, such as field, defined, including predefined, for a criteria for a document class to use by an administrator programmed in a data processing system may be accessed and applied, as described below in additional detail.

Search layer 320 generally includes reference numbers 311 through 316. Searching for metadata matches and content matches between an in-process document and documents in a database in a document class thereof was previously described and the following is an example for these searches and possible identification of matching metadata or content, if any. Assuming one or more metadata matched documents 312 are found from a search operation at operation 313 of a database where such search operation may have been initiated at operation 311, for each of such found matching documents identified by one or more metadata matches at operation 311, at operation 313 content duplicates may be identified between an in-process document document and each corresponding one of such metadata matched documents 312 found in a database associated with such one or more metadata matches as part of a database search operation at 331.

In this example, one or more metadata matched documents 312 may be returned from a database search operation at 331. However, in another example just pointer information to one or more metadata matched documents 312 may be returned as generally indicated with a dotted line between operation 311 and one or more metadata matched documents 312.

From operation 303, at operation 311 identified metadata at 303 may be used to search for matching metadata in existing stored documents, such as previously described, in a database, such as for example database 106. From operation 303, at operation 313 an identified document class may be used to search for matching content in one or more stored documents, such as for example database 106, in a same document class, such as previously described.

A table or list of monitored filed for each class of documents may be stored, such as list 315 for example. Such monitored fields may include one or more of names of contractual parties, contractual purpose, amount of consideration, named intellectual property, among other business fields which may vary among document classes.

From operation 313, at operation 314 using list 315 changes in such monitored fields may be identified for each matched document, if any, identified at operation 313. Such changes may between a matching document having monitored field information and field information stored in list 315 for corresponding fields. In this example, a matching document 316 is not retrieved from a database as a database operation 313, but rather just monitored field data 316 for each such matching document may be accessed.

After searching for and identifying one or more document matches responsive to searching for content matches at operation 313 and after identifying each change, if any, in data fields of a monitoring criteria implemented as a list 315 for each one or more document matches at operation 314, results from operations 313 and 314 may be used to determine at operation 321 whether to send an alert.

Parsing and alerting layer 330 generally includes reference numbers 321 through 314. If at operation 321 it is determined that an alert is to be sent, such as previously described, then at operation 306 such an alert may be sent to a document class manager or DCM regarding any and all content duplicates and each said change, if any in one or more monitored data fields.

At operation 307, a DCM, such as an agent 121 or a supervisor 130, may process such information received to at operation 308 determine whether or not to approve an upload of a new addition document to a database or a modification of an existing stored document in a database. If at operation 308 a DCM decides to approve uploading of a new addition document or edits to a previously stored document, then at operation 309 such DCM may decide how to store such an uploaded, as previously described. In other words, a DCM may provide storage instructions, which may include duration and destination information, for storing such an uploaded document or edits. Such instruction may be to enhance storage resource utilization, including reducing costs by using less costly storage resources or using less storage resources, associated with a data processing system.

If a DCM approves at 308 a change to a document in a database or a new addition to a database of documents then such change or addition is stored; otherwise, a user 301 who may have originated an editing or uploading of such a document may be provided with a denial error message 301m, which may include reasoning for such denial.

For an approved upload, storage instructions issued at operation 309 may be applied at operation 324. As previously described, in an example storage instruction may include cold-, warm- or hot-level of storage.

At operation 322, duplicate content identified at operation 313 and provided for operation 322 may be isolated from non-duplicate content, namely parsing “common content” and “specific content” from one another. In this example, a page-wise isolation of identified duplicate content is used. However, in another example, a section-by-section isolation of identified duplicate content may be used.

At operation 323, common or duplicate content may be separated or otherwise parsed from document specific content of an in-process document, the latter of which may generally be thought of as “unique” content for purposes of clarity and not limitation. In this example, such separation is performed on a page-by-page basis; however, in another example a section-by-section or other content delineating reference or index may be used.

At operation 321, it may be determined that no alert is to be send to a DCM, in which event operation 322 may be performed without any storage instructions from operation 324 but with any and all identified duplicate content from operation 313. Whether an alert is sent or not as determined at operation 321 was previously described herein.

Storage layer 340 generally includes reference numbers 331 through 333. From separating common and specific content at operation 323, common content 332 may be sent to a database for a database storage or pointing operation 331 as a template, and specific content 333 may be send to a database for a database storage operation 331. Again, in this example, each page of common content may be sent, but in another example each section of common content may be sent. For purposes of clarity by way of example and not limitation, common content may be used for providing a template, such as for contracts or other business documents, or may be associated with an existing template stored in a database, where either a storage or a pointing database operation 331 may respectively be used.

In this example, each page or section of specific content per document 333 may be provided to a database for a database storage operation 331. Again, as such storage was previously described herein such description is not repeated for purposes of clarity and not limitation.

Because one or more of the examples described herein may be implemented using an information processing system, a detailed description of examples of each of a network (such as for a Cloud-based XaaS (Everything-as-a-Service) implementation), a computing system, a mobile device, and an MFP is provided. However, it should be understood that other configurations of one or more of these examples may benefit from the technology described herein.

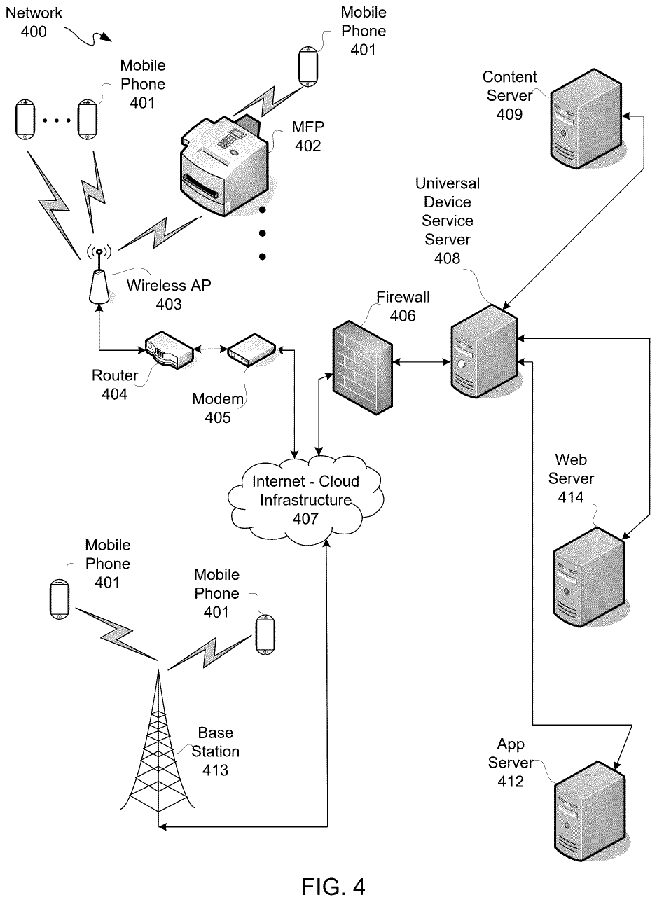

FIG. 4 is a pictorial diagram depicting an example of a network 400, which may be used to provide a SaaS platform for hosting a service or micro service for use by a user device, as described herein. Along those lines, network 400 may include one or more mobile phones, pads/tablets, notebooks, and/or other web-usable devices 401 in wired and/or wireless communication with a wired and/or wireless access point (“AP”) 403 connected to or of a wireless router. Furthermore, one or more of such web-usable wireless devices 401 may be in wireless communication with a base station 413.

Additionally, a desktop computer and/or a printing device, such as for example one or more multi-function printer (“MFPs”) 402, each of which may be web-usable devices, may be in wireless and/or wired communication to and from router 404. An MFP 402 may include at least one plasma head as previously described herein.

Wireless AP 403 may be connected for communication with a router 404, which in turn may be connected to a modem 405. Modem 405 and base station 413 may be in communication with an Internet-Cloud infrastructure 407, which may include public and/or private networks.

A firewall 406 may be in communication with such an Internet-Cloud infrastructure 407. Firewall 406 may be in communication with a universal device service server 408. Universal device service server 408 may be in communication with a content server 409, a web server 414, and/or an app server 412. App server 412, as well as a network 400, may be used for downloading an app or one or more components thereof for accessing and using a service or a micro service as described herein.

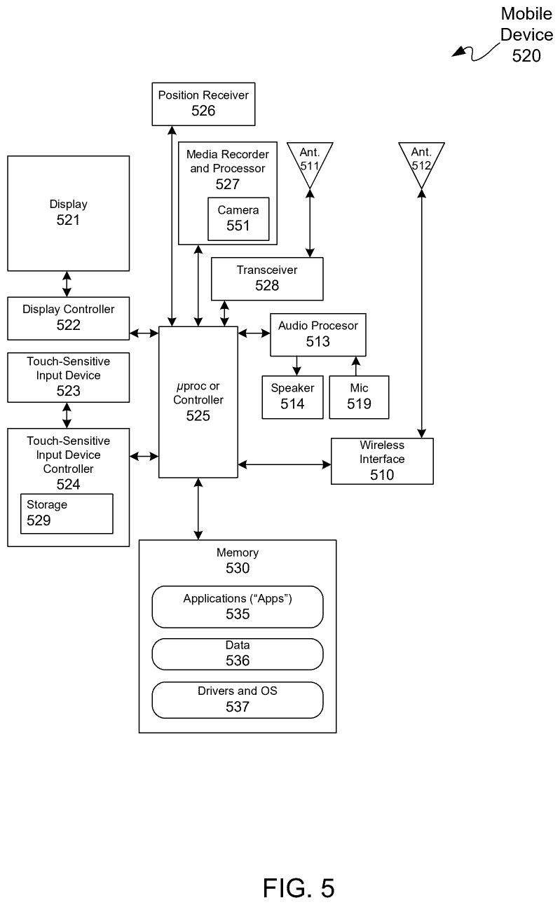

FIG. 5 is a block diagram depicting an example of a portable communication device (“mobile device”) 520. Mobile device 520 may be an example of a mobile device used to instruct a printing device.

Mobile device 520 may include a wireless interface 510, an antenna 511, an antenna 512, an audio processor 513, a speaker 514, and a microphone (“mic”) 519, a display 521, a display controller 522, a touch-sensitive input device 523, a touch-sensitive input device controller 524, a microprocessor or microcontroller 525, a position receiver 526, a media recorder 527, a cell transceiver 528, and a memory or memories (“memory”) 530.

Microprocessor or microcontroller 525 may be programmed to control overall operation of mobile device 520. Microprocessor or microcontroller 525 may include a commercially available or custom microprocessor or microcontroller.

Memory 530 may be interconnected for communication with microprocessor or microcontroller 525 for storing programs and data used by mobile device 520. Memory 530 generally represents an overall hierarchy of memory devices containing software and data used to implement functions of mobile device 520. Data and programs or apps, such as a mobile client application as described hereinabove, may be stored in memory 530.

Memory 530 may include, for example, RAM or other volatile solid-state memory, flash or other non-volatile solid-state memory, a magnetic storage medium such as a hard disk drive, a removable storage media, or other suitable storage means. In addition to handling voice communications, mobile device 520 may be configured to transmit, receive and process data, such as Web data communicated to and from a Web server, text messages (also known as short message service or SMS), electronic mail messages, multimedia messages (also known as MMS), image files, video files, audio files, ring tones, streaming audio, streaming video, data feeds (e.g., podcasts), and so forth.

In this example, memory 530 stores drivers, such as I/O device drivers, and operating system programs (“OS”) 537. Memory 530 stores application programs (“apps”) 535 and data 536. Data may include application program data.

I/O device drivers may include software routines accessed through microprocessor or microcontroller 525 or by an OS stored in memory 530. Apps, to communicate with devices such as the touch-sensitive input device 523 and keys and other user interface objects adaptively displayed on a display 521, may use one or more of such drivers.

Mobile device 520, such as a mobile or cell phone, includes a display 521. Display 521 may be operatively coupled to and controlled by a display controller 522, which may be a suitable microcontroller or microprocessor programmed with a driver for operating display 521.

Touch-sensitive input device 523 may be operatively coupled to and controlled by a touch-sensitive input device controller 524, which may be a suitable microcontroller or microprocessor. Along those lines, touching activity input via touch-sensitive input device 523 may be communicated to touch-sensitive input device controller 524. Touch-sensitive input device controller 524 may optionally include local storage 529.

Touch-sensitive input device controller 524 may be programmed with a driver or application program interface (“API”) for apps 535. An app may be associated with a service, as previously described herein, for use of a SaaS. One or more aspects of above-described apps may operate in a foreground or background mode.

Microprocessor or microcontroller 525 may be programmed to interface directly touch-sensitive input device 523 or through touch-sensitive input device controller 524. Microprocessor or microcontroller 525 may be programmed or otherwise configured to interface with one or more other interface device(s) of mobile device 520. Microprocessor or microcontroller 525 may be interconnected for interfacing with a transmitter/receiver (“transceiver”) 528, audio processing circuitry, such as an audio processor 513, and a position receiver 526, such as a global positioning system (“GPS”) receiver. An antenna 511 may be coupled to transceiver 528 for bi-directional communication, such as cellular and/or satellite communication.

Mobile device 520 may include a media recorder and processor 527, such as a still camera 551, a video camera, an audio recorder, or the like, to capture digital pictures, audio and/or video. Microprocessor or microcontroller 525 may be interconnected for interfacing with media recorder and processor 527. Image, audio and/or video files corresponding to the pictures, songs and/or video may be stored in memory 530 as data 536.

Mobile device 520 may include an audio processor 513 for processing audio signals, such as for example audio information transmitted by and received from transceiver 528. Microprocessor or microcontroller 525 may be interconnected for interfacing with audio processor 513. Coupled to audio processor 513 may be one or more speakers 514 and one or more microphones 519, for projecting and receiving sound, including without limitation recording sound, via mobile device 520. Audio data may be passed to audio processor 513 for playback. Audio data may include, for example, audio data from an audio file stored in memory 530 as data 536 and retrieved by microprocessor or microcontroller 525. Audio processor 513 may include buffers, decoders, amplifiers and the like.

Mobile device 520 may include one or more local wireless interfaces 510, such as a WIFI interface, an infrared transceiver, and/or an RF adapter. Wireless interface 510 may provide a Bluetooth adapter, a WLAN adapter, an Ultra-Wideband (“UWB”) adapter, and/or the like. Wireless interface 510 may be interconnected to an antenna 512 for communication. As is known, a wireless interface 510 may be used with an accessory, such as for example a hands-free adapter and/or a headset. For example, audible output sound corresponding to audio data may be transferred from mobile device 520 to an adapter, another mobile radio terminal, a computer, or another electronic device. In another example, wireless interface 510 may be for communication within a cellular network or another Wireless Wide-Area Network (WWAN).

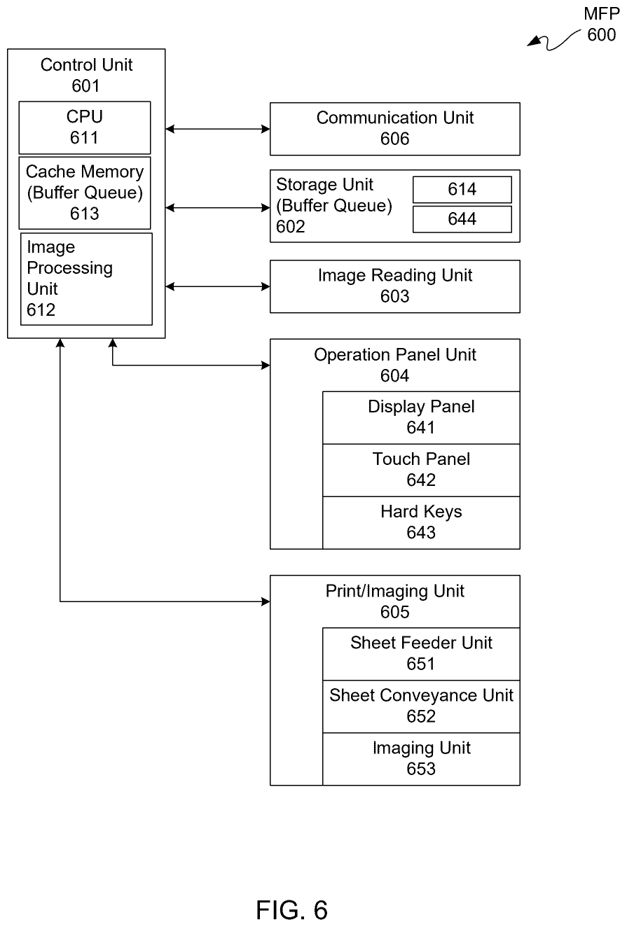

FIG. 6 is a block diagram depicting an example of a multi-function printer MFP 600. MFP 600 is provided for purposes of clarity by way of non-limiting example. MFP 600 is an example of an information processing system such as for handling a printer job.

MFP 600 includes a control unit 601, a storage unit 602, an image reading unit 603, an operation panel unit 604, a print/imaging unit 605, and a communication unit 606. Communication unit 606 may be coupled to a network for communication with other peripherals, mobile devices, computers, servers, and/or other electronic devices. Control unit 601 may include a CPU 611, an image processing unit 612, and cache memory 613.

Control unit 601 may be included with or separate from other components of MFP 600. Storage unit 602 may include ROM, RAM, and large capacity storage memory, such as for example an HDD or an SSD. Storage unit 602 may store various types of data and control programs, including without limitation a printer imaging pipeline program 614 and a printer job settings app 644. A buffer queue may be located in cache memory 613 or storage unit 602.

Operation panel unit 604 may include a display panel 641, a touch panel 642, and hard keys 643. Print/imaging unit 605 may include a sheet feeder unit 651, a sheet conveyance unit 652, and an imaging unit 653.

Generally, for example, for an MFP a copy image processing unit, a scanner image processing unit, and a printer image processing unit may all be coupled to respective direct memory access controllers for communication with a memory controller for communication with a memory. Many known details regarding MFP 600 are not described for purposes of clarity and not limitation.

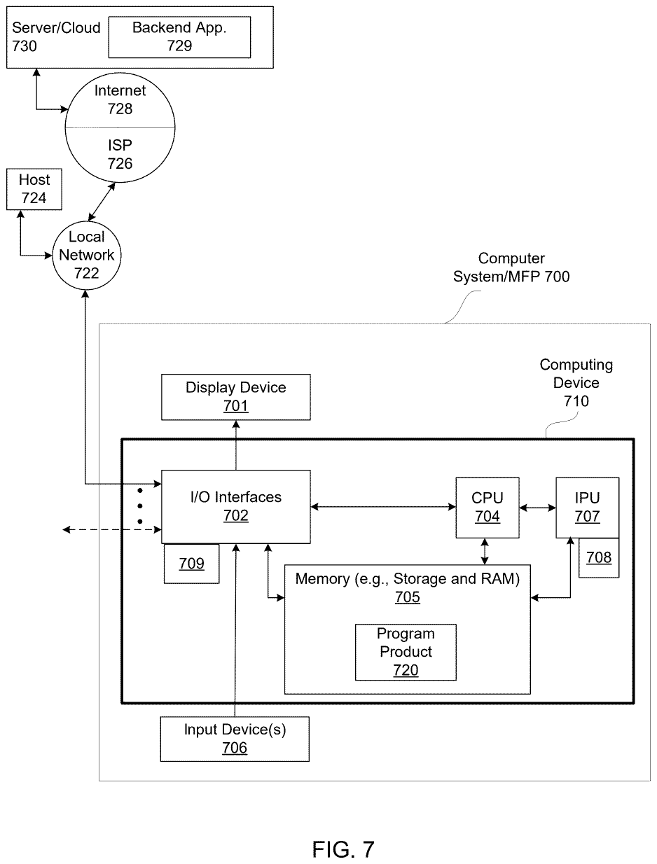

FIG. 7 is a block diagram depicting an example of a computer system or MFP 700 (“computer system”) upon which one or more aspects described herein may be implemented. Computer system 700 may include a programmed computing device 710 coupled to one or more display devices 701, such as Cathode Ray Tube (“CRT”) displays, plasma displays, Liquid Crystal Displays (“LCDs”), Light Emitting Diode (“LED”) displays, light emitting polymer displays (“LPDs”) projectors and to one or more input devices 706, such as a keyboard and a cursor pointing device. Other known configurations of a computer system may be used. Computer system 700 by itself or networked with one or more other computer systems 700 may provide an information handling/processing system.

Programmed computing device 710 may be programmed with a suitable operating system, which may include Mac OS, Java Virtual Machine, Real-Time OS Linux, Solaris, iOS, Darwin, Android Linux-based OS, Linux, OS-X, UNIX, or a Windows operating system, among other platforms, including without limitation an embedded operating system, such as VxWorks. Programmed computing device 710 includes a central processing unit (“CPU”) 704, one or more memories and/or storage devices (“memory”) 705, and one or more input/output (“I/O”) interfaces (“I/O interface”) 702. Programmed computing device 710 may optionally include an image processing unit (“IPU”) 707 coupled to CPU 704 and one or more peripheral cards 709 coupled to I/O interface 702. Along those lines, programmed computing device 710 may include graphics memory 708 coupled to optional IPU 707.

CPU 704 may be a type of microprocessor known in the art, such as available from IBM, Intel, ARM, and Advanced Micro Devices for example. CPU 704 may include one or more processing cores. Support circuits (not shown) may include busses, cache, power supplies, clock circuits, data registers, and the like.

Memory 705 may be directly coupled to CPU 704 or coupled through I/O interface 702. At least a portion of an operating system may be disposed in memory 705. Memory 705 may include one or more of the following: flash memory, random access memory, read only memory, magneto-resistive read/write memory, optical read/write memory, cache memory, magnetic read/write memory, and the like, as well as non-transitory signal-bearing media as described below. For example, memory 705 may include an SSD, which is coupled to I/O interface 702, such as through an NVMe-PCle bus, SATA bus or other bus. Moreover, one or more SSDs may be used, such as for NVMe, RAID or other multiple drive storage for example.

I/O interface 702 may include chip set chips, graphics processors, and/or daughter cards, among other known circuits. In this example, I/O interface 702 may be a Platform Controller Hub (“PCH”). I/O interface 702 may be coupled to a conventional keyboard, network, mouse, camera, microphone, display printer, and interface circuitry adapted to receive and transmit data, such as data files and the like.

Programmed computing device 710 may optionally include one or more peripheral cards 709. An example of a daughter or peripheral card may include a network interface card (“NIC”), a display interface card, a modem card, and a Universal Serial Bus (“USB”) interface card, among other known circuits. Optionally, one or more of these peripherals may be incorporated into a motherboard hosting CPU 704 and I/O interface 702. Along those lines, IPU 707 may be incorporated into CPU 704 and/or may be of a separate peripheral card.

Programmed computing device 710 may be coupled to a number of client computers, server computers, or any combination thereof via a conventional network infrastructure, such as a company's Intranet and/or the Internet, for example, allowing distributed use. Moreover, a storage device, such as an SSD for example, may be directly coupled to such a network as a network drive, without having to be directly internally or externally coupled to programmed computing device 710. However, for purposes of clarity and not limitation, it shall be assumed that an SSD is housed in programmed computing device 710.

Memory 705 may store all or portions of one or more programs or data, including variables or intermediate information during execution of instructions by CPU 704, to implement processes in accordance with one or more examples hereof to provide a program product 720. Program product 720 may be for implementing portions of process flows, as described herein. Additionally, those skilled in the art will appreciate that one or more examples hereof may be implemented in hardware, software, or a combination of hardware and software. Such implementations may include a number of processors or processor cores independently executing various programs, dedicated hardware and/or programmable hardware.

Along those lines, implementations related to use of computing device 710 for implementing techniques described herein may be performed by computing device 710 in response to CPU 704 executing one or more sequences of one or more instructions contained in main memory of memory 705. Such instructions may be read into such main memory from another machine-readable medium, such as a storage device of memory 705. Execution of the sequences of instructions contained in main memory may cause CPU 704 to perform one or more process steps described herein. In alternative implementations, hardwired circuitry may be used in place of or in combination with software instructions for such implementations. Thus, the example implementations described herein should not be considered limited to any specific combination of hardware circuitry and software, unless expressly stated herein otherwise.

One or more program(s) of program product 720, as well as documents thereof, may define functions of examples hereof and can be contained on a variety of non-transitory tangible signal-bearing media, such as computer-or machine-readable media having code, which include, but are not limited to: (i) information permanently stored on non-writable storage media (e.g., read-only memory devices within a computer such as CD-ROM or DVD-ROM disks readable by a CD-ROM drive or a DVD drive); or (ii) alterable information stored on writable storage media (e.g., floppy disks within a diskette drive or flash drive or hard-disk drive or read/writable CD or read/writable DVD).

Computer readable storage media encoded with program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. In implementations, information downloaded from the Internet and other networks may be used to provide program product 720. Such transitory tangible signal-bearing media, when carrying computer-readable instructions that direct functions hereof, represent implementations hereof.

Along those lines the term “tangible machine-readable medium” or “tangible computer-readable storage” or the like refers to any tangible medium that participates in providing data that causes a machine to operate in a specific manner. In an example implemented using computer system 700, tangible machine-readable media are involved, for example, in providing instructions to CPU 704 for execution as part of programmed product 720. Thus, a programmed computing device 710 may include programmed product 720 embodied in a tangible machine-readable medium. Such a medium may take many forms, including those describe above.

The term “transmission media”, which includes coaxial cables, conductive wire and fiber optics, including traces or wires of a bus, may be used in communication of signals, including a carrier wave or any other transmission medium from which a computer can read. Transmission media can also take the form of acoustic or light waves, such as those generated during radio-wave and infra-red data communications.

Various forms of tangible signal-bearing machine-readable media may be involved in carrying one or more sequences of one or more instructions to CPU 704 for execution. For example, instructions may initially be carried on a magnetic disk or other storage media of a remote computer. The remote computer can load the instructions into its dynamic memory and send such instructions over a transmission media using a modem. A modem local to computer system 700 can receive such instructions on such transmission media and use an infra-red transmitter to convert such instructions to an infra-red signal. An infra-red detector can receive such instructions carried in such infra-red signal and appropriate circuitry can place such instructions on a bus of computing device 710 for writing into main memory, from which CPU 704 can retrieve and execute such instructions. Instructions received by main memory may optionally be stored on a storage device either before or after execution by CPU 704.

Computer system 700 may include a communication interface as part of I/O interface 702 coupled to a bus of computing device 710. Such a communication interface may provide a two-way data communication coupling to a network link connected to a local network 722. For example, such a communication interface may be a local area network (“LAN”) card to provide a data communication connection to a compatible LAN. Wireless links may also be implemented. In any such implementation, a communication interface sends and receives electrical, electromagnetic or optical signals that carry digital and/or analog data and instructions in streams representing various types of information.

A network link to local network 722 may provide data communication through one or more networks to other data devices. For example, a network link may provide a connection through local network 722 to a host computer 724 or to data equipment operated by an Internet Service Provider (“ISP”) 726 or another Internet service provider. ISP 726 may in turn provide data communication services through a world-wide packet data communication network, the “Internet” 728. Local network 722 and the Internet 728 may both use electrical, electromagnetic or optical signals that carry analog and/or digital data streams. Data carrying signals through various networks, which carry data to and from computer system 700, are exemplary forms of carrier waves for transporting information.

Wireless circuitry of I/O interface 702 may be used to send and receive information over a wireless link or network to one or more other devices' conventional circuitry such as an antenna system, an RF transceiver, one or more amplifiers, a tuner, one or more oscillators, a digital signal processor, a CODEC chipset, memory, and the like. In some implementations, wireless circuitry may be capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, WIFI (such as IEEE 802.11a, IEEE 802.11b, IEEE 802.11g and/or IEEE 802.11n), Bluetooth, Wi-MAX, voice over Internet Protocol (VoIP), near field communication protocol (NFC), a protocol for email, instant messaging, and/or a short message service (SMS), or any other suitable communication protocol. A computing device can include wireless circuitry that can communicate over several different types of wireless networks depending on the range required for the communication. For example, a short-range wireless transceiver (e.g., Bluetooth), a medium-range wireless transceiver (e.g., WIFI), and/or a long range wireless transceiver (e.g., GSM/GPRS, UMTS, CDMA2000, EV-DO, and LTE/LTE-Advanced) can be used depending on the type of communication or the range of the communication.

Computer system 700 can send messages and receive data, including program code, through network(s) via a network link and communication interface of I/O interface 702. In the Internet example, a server 730 might transmit a requested code for an application program through Internet 728, ISP 726, local network 722 and I/O interface 702. A server/Cloud-based system 730 may include a backend application for providing one or more applications or services as described herein.

Received code may be executed by processor 704 as it is received, and/or stored in a storage device, or other non-volatile storage, of memory 705 for later execution. In this manner, computer system 700 may obtain application code in the form of a carrier wave.

While the foregoing describes exemplary apparatus(es) and/or method(s), other and further examples in accordance with the one or more aspects described herein may be devised without departing from the scope hereof, which is determined by the claims that follow and equivalents thereof. Claims listing steps do not imply any order of the steps. Trademarks are the property of their respective owners.

1. In a data processing system having a memory, a method comprising the computer-implemented steps of:
defining one or more data cells to look at in a document class by an administrator programmed in the data processing system;
automatically comparing by the administrator a document with documents in a database belonging to the document class of the document with respect to the one or more data cells for the document class;
searching across the database to look for matching content in the one or more data cells using a monitoring criteria as applied between the document and the documents in the database to identify each content match meeting the monitoring criteria as duplicate content with respect to the one or more data cells for the document class;
determining whether to send an alert to a document class manager for the document class responsive to the monitoring criteria being met;
responsive to the monitoring criteria being met for the document in the database as found by the administrator, alerting the document class manager for the document class to confirm a next operation for the document to enhance storage resource utilization of the data processing system.

2. The method according to claim 1, wherein:
the document includes defined content and data fields for the content;
the monitoring criteria includes a 90% threshold level for each said content match; and
the document is either a newly uploaded or an edited version in the database.

3. The method according to claim 1, wherein the next operation includes:
removing the duplicate content from the document;
pointing to the duplicate content stored in the database for the document; and
storing any specific content of the document remaining in the database.

4. The method according to claim 1, wherein the one or more data cells are one or more fields predefined through configuration settings accessible via a dashboard associated with the document class manager.

5. The method according to claim 1, further comprising the computer-implemented step of adding one or more metadata attributes in addition to the document class to the monitoring criteria.

6. The method according to claim 3, wherein the removing includes using split aggregation of the document by having the pointing be to a template for the document with the duplicate content.

7. The method according to claim 1, wherein the next operation includes sending either the document or the duplicate content to archival storage.

8. A system, comprising:
equipment for document processing with each having:
a memory configured to store program code; and
a processor coupled to the memory;
a cloud-based application of a cloud computing system in networked communication with the equipment;
wherein, in combination and response to executing the program code, the equipment and the cloud-based application combination is configured to facilitate performance of operations, comprising:
uploading a document that is either a newly uploaded or an edited version to documents in a database;
defining one or more data cells to look at with a monitoring criteria by an administrator programmed in the data processing system;
automatically comparing by the administrator the document with the documents in the database belonging to a same document class as the document with respect to the one or more data cells for the document class;
searching across the database to look for matching content in the one or more data cells using the monitoring criteria as applied between the document and the documents in the database to identify each content match meeting the monitoring criteria as duplicate content with respect to the one or more data cells for the document class;
determining whether to send an alert to a document class manager for the document class responsive to the monitoring criteria being met;
responsive to the monitoring criteria being met for the document in the database as found by the administrator, alerting the document class manager for the document class to confirm a next operation for the document to enhance storage resource utilization of the data processing system; and
wherein the next operation includes:
removing the duplicate content from the document;
pointing to the duplicate content stored in the database for the document; and
storing any specific content of the document remaining in the database.

9. The system according to claim 8, wherein:
the monitoring criteria includes a 90% threshold level for each said content match; and
the removing includes using split aggregation of the document by having the pointing be to a template for the document with the duplicate content stored in the database.

10. The system according to claim 9, wherein the one or more data cells are one or more fields predefined through configuration settings accessible via a dashboard associated with the document class manager.

11. The system according to claim 10, further comprising the computer-implemented step of adding one or more metadata attributes in addition to the document class to the monitoring criteria.

12. The system according to claim 11, wherein the alerting of the document class manager includes sending an alert to inform a human supervisor of the document class manager of an upload of the document to the database.

13. A non-transitory machine-readable storage medium, comprising executable instructions that, when executed by a processor, facilitate performance of operations, comprising:
uploading a new or edited version of a document to documents in a database;
defining data cells for a monitoring criteria for a document class to use by an administrator programmed in a data processing system;
searching for content matches in the data cells using the monitoring criteria as applied between the document and the documents in the database in the document class to identify each content match meeting the monitoring criteria with respect to the data cells for the document class;
identifying one or more document matches responsive to the searching for the content matches;
identifying each change in the data cells responsive to the monitoring criteria for each of the one or more document matches;
searching for metadata matches between the document and the documents in the database;
identifying one or more metadata matches responsive to the searching;
identifying content duplicates between the document and each corresponding one of the documents in the database associated with the one or more metadata matches;
sending an alert to a document class manager responsive to the content duplicates and each said change in the data cells;
approving the uploading by the document class manager of the document; and
determining by the document class manager storage instructions associated with storing the document.

14. The non-transitory machine-readable storage medium according to claim 13, further comprising:
isolating duplicate content found in both the document and the database from specific content of the document; and
the monitoring criteria includes a 90% threshold level for each said content match.

15. The non-transitory machine-readable storage medium according to claim 14, wherein the isolating is on a section-by-section basis of the document.

16. The non-transitory machine-readable storage medium according to claim 15, wherein the isolating includes separating common pages and specific pages of the document from one another.

17. The non-transitory machine-readable storage medium according to claim 16, wherein the common pages correspond to one or more stored templates in the database.

18. The non-transitory machine-readable storage medium according to claim 13, wherein the storage instructions include removing duplicate content of the content duplicates from the document found in the database by pointing to the duplicate content corresponding thereto previously stored in the database.

19. The non-transitory machine-readable storage medium according to claim 18, further comprising:
removing the duplicate content from the document;
pointing to the duplicate content stored in the database for the document; and
storing any specific content of the document remaining in the database.

20. The non-transitory machine-readable storage medium according to claim 19, wherein:
the storage instructions include cold, warm or hot storage information; and
the removing includes using split aggregation of the document by having the pointing be to a template for the document with the duplicate content.
